(19) United States
(12) Patent Application Publication
(10) Pub. No.: US 2019/0172089 A1
(43) Pub. Date: Jun. 6, 2019

(54) NORMALIZING USER INTERACTIONS FOR THIRD-PARTY SYSTEMS

(71) Applicant: Facebook, Inc., Menlo Park, CA (US)

(72) Inventors: Junbiao Tang, Mercer Island, WA (US); Alexander Pivovarov, Kirkland, WA (US); Anand Sumatilal Bhalgat, Mountain View, CA (US); Janis Libeks, Seattle, WA (US); Hao Zhang, Fremont, CA (US); Yevgeniya Solyanik, Seattle, WA (US)

(21) Appl. No.: 15/829,841

(22) Filed: Dec. 1, 2017

(51) Int. Cl. G06Q 30/02

(52) U.S. Cl. CPC G06Q 30/0242; G06N 7/005; G06Q 30/0246

(57) ABSTRACT

An online system determines an estimated conversion rate for sponsored content items placed on content publishers and on the online system. The estimated conversion rate can be determined by a machine learning model trained using data describing content campaigns, content publishers, and online system users. This data is collected by the online system from content publishers and/or content campaigns that report conversion rates to the online system. By determining a ratio of estimated conversion rates with third party content on the content publisher against those on the online system, the online system can determine a publisher quality score for that content publisher. The online system uses the publisher quality score to normalize third party value contributions toward placing sponsored content on content publishers and the online system. Thus, disparities in the intrinsic value across publishers are diminished as third party value contributions are normalized based on the publisher conversion rates.

### BACKGROUND

This invention relates generally to evaluating the quality of a content publisher, and particularly to evaluating the likelihood of a group of users interacting with content items featured on the content publisher.

Publishers provide content for users to consume in an interactive system. Such interactive systems may be websites, games, applications, or other electronic interactive systems of interest to a user. When providing the content to users, a publisher may develop a layout or other interactive flow in which the user interacts with the publisher. Within the layout, the publisher may provide a slot for content selected by another system or for placement of sponsored content provided by a third party system. Content is selected based on a bidding process in which third party systems provide a value contribution in exchange for placing their sponsored content within the slot provided by the publisher.

Third party value contribution is based on criteria associated with a particular sponsored content campaign initiated by a third party. Typically, the criteria indicate parameters such as targeting criteria, sponsored content type, slot type, value contribution amount, and the like. A given campaign is selected when the criteria match with that specified by the publisher. Typically a user's interaction with the content placed in a slot is beneficial for the publisher, for example to encourage the user to take a behavior related to the content selected for the slot. The behavior may directly or indirectly benefit the publisher. However, third parties providing the content typically have lacked the tools to evaluate the performance of the publisher on which their content is placed. Some publishers do not report user interactions with content placed in slots, or report incorrect information regarding user interactions with content. Resultantly, one value contribution amount is applied across all publishers that feature slots in which content will be placed, regardless of the amount of user traffic a publisher generates or the likelihood that a user will interact with the content.

### SUMMARY

An online system accounts for different publisher interaction rates by determining a publisher quality score to account for per-publisher placement deviations in content interactions. The publisher quality score is used to adjust an estimated interaction rate for the content according to the particular publisher being evaluated. The estimated interaction rate can be determined by the online system using data describing content campaigns, content publishers, and online system users. This data is collected by the online system from content publishers and/or content campaigns that report user interactions with content to the online system. The estimated interaction rate may directly predict a user's interaction rate with the content, irrespective of publishing placement. This estimated interaction rate may then be adjusted by the publisher quality score to account for the expected effect of placing the content item on the particular publisher. The publisher quality score may be determined by effects of the per-placement ratio of user interactions with third party content featured within the content publisher against those user interactions within the online system. This may be used by the online system to determine an estimated interaction rate for that given content publisher for that content. The online system can thus use this approach to identify additional content publishers and/or campaigns for which user interactions are not reported, or not yet generated, and determine an estimated interaction rate for each content publisher and/or campaign. The online system uses this publisher quality score to normalize the estimated interaction rate and third party value contributions toward placing sponsored content on that given publisher. Thus, disparities in the intrinsic value across publishers are accounted for as third party value contributions are normalized based on the expected publisher conversion rates.

### BRIEF DESCRIPTION OF THE DRAWINGS

FIG. 1 is a block diagram of a system environment for generating a publisher quality score, according to one embodiment.

FIG. 2 is a block diagram of an online system having a publisher quality score generator, according to one embodiment.

FIG. 3A is a block diagram of content slots presented in a content publisher, according to one embodiment.

FIG. 3B is a block diagram of content slots presented in an online system, according to one embodiment.

FIG. 4 is a diagram illustrating a collection of campaign information, according to one embodiment.

FIG. 5A is a diagram illustrating a campaign vector, publisher vector, and user vector, according to one embodiment.

FIG. 5B is a diagram illustrating a process for applying a machine learning model to determine a predicted conversion rate for a content publisher, according to one embodiment.

FIG. 6 is a flowchart illustrating a process for generating a publisher quality score for a given publisher and normalizing a third party contribution, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

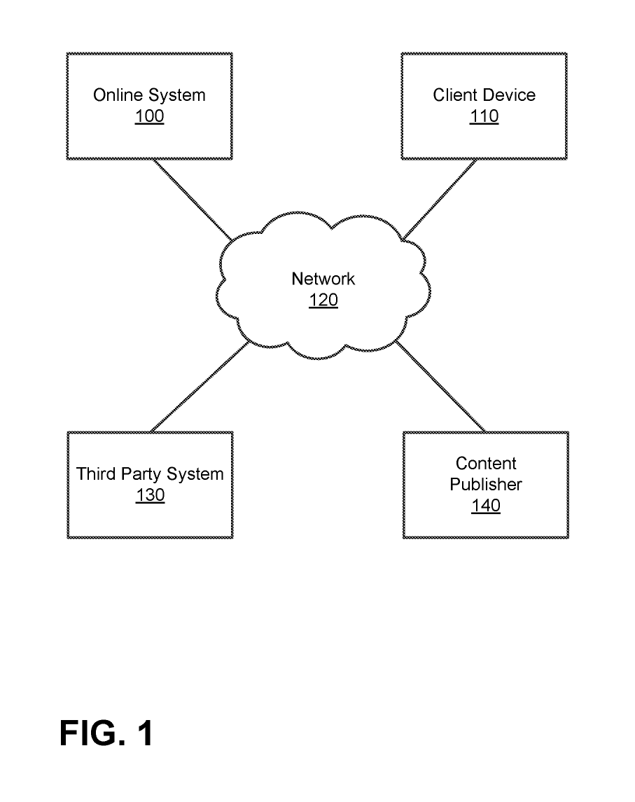

FIG. 1 is a block diagram of a system environment for generating publisher quality scores for content publishers. The system environment includes an online system 100, a client device 110, a network 120, a third party system 130, and a content publisher 140. In other embodiments, different and/or additional entities can be included in the system architecture. The online system 100 provides content items, such as sponsored content items, to users of the client devices 110 to access the content publisher 140 or an application controlled by the content publisher 140. Sponsored content items are also provided to users by other publishing platforms, such as presenting the sponsored content items on the online system 100. The online system 100 evaluates performance of the content items in slots featured on the content publisher 140 in comparison to those presented within the online system 100 to determine the comparative performance of the content publisher's 140 slots in promoting the content items and associated interactions with the content items. As the evaluation may be performed with respect to subsets of online system 100 users, sponsored content campaigns, and content publishers 140, the online system 100 may use the behavior of users (e.g., interaction with content slots) within a given content publisher 140 to adjust the value that a third party system 130 might contribute toward placing content items within that content publisher 140. In addition, the comparative performance of a content publisher 140 may also reflect poor representation of content items featured on the content publisher 140, and the online system 100 may also use the comparative scores to modify what content items may be presented on the content publisher 140.

The online system 100 includes a computing environment that allows users of the online system 100 to communicate or otherwise interact with each other and access content. The online system 100 stores information about the users, for example, user profile information and information about actions performed by users on the online system 100. The online system 100 maintains content items for presentation to users via publication platforms, such as the content publisher 140 or via another publication channel, which may be operated by the online system 100. When an available slot is identified, the online system selects a content item for presentation in the available slot from various content items that may be presented to users. As users interact with the content publisher 140 (or an application provided by the content publisher), the online system 100 provides content items for available slots. The selected content items may be provided by third party systems 130 and may include a value to a third party system 130 when an action is performed by a user responsive to the selection of the content item. The online system 100 may select from among these content items based on the value associated with each content item provided.

The online system 100 selects sponsored content items to be presented to an online system 100 user. The selected content may be provided to the user when the user accesses the online system 100, for example to view content of the online system 100, or may be provided to the user when the user accesses the content publisher 140 or interacts with a content publisher's application. When the online system 100 or a content publisher 140 (or the content publisher's application on the device) has a location (or slot) in which sponsored content may be placed by the online system 100, the online system 100 receives a request to select content for the location and provides the selected content item for display in that location. In one embodiment, the online system 100 selects sponsored content items from the available sponsored content campaigns stored in a content store. In other embodiments, the online system 100 selects sponsored content items from available sponsored content campaigns stored in another system, external to the online system 100. The online system 100 examines criteria associated with each sponsored content campaign and selects one or more sponsored content items for presentation to the user. To select the sponsored content, for example, the online system 100 identifies sponsored content campaigns that target a particular user, and perform an auction for placement in the slot based on the expected value of each sponsored content item for placement in the slot.

The client device 110 is a computing device capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 100. For example, a client device 110 executes a browser application to enable interaction between the client device 110 and the online system 100 via the network 120. In another embodiment, a client device 110 interacts with the online system 100 through an application programming interface (API) running on a native operating system of the client device 110, such as IOS® or ANDROID™. The client device 110 may interact with the content publisher 140 to view and retrieve content from the content publisher 140. In some embodiments, the client device 110 retrieves and executes an application provided by the content publisher 140. Within the application (or while the client device 110 accesses content at the third party system 130), content slots may be specified for which content is retrieved from the online system 100. The content slots may be located within the content of the content publisher 140 according to a layout specified by the content publisher 140. When content items are retrieved from the online system 100, users may interact with the retrieved content items, for example to access a related page or perform another interaction associated with the selected content item.

One or more third party systems 130 may be coupled to the network 120 for communicating with the online system 100. The third party systems 130 provide content items to the online system 100 for selection and presentation to users of the client devices 110. The content items may describe applications for execution by a client device 110 or other content for a user to interact with. The third party system 130 may provide the content items as sponsored content that encourages a user's action based on placement of the content item to a user, and may also provide a value to the online system 100 and/or content publisher 140 when the content item is provided to the user or when the user performed the designated action. For example, the third party system 130 may provide information about products or services provided by the third party system that may be of interest to users. When users express an interest in or interact with the content, the third party system 130 may provide value to the online system 100 or the content publisher 140 for providing the content to users. Thus, the third party system 130 may represent a company offering a product, service, or message that the company wishes to promote to users of the client devices 110.

The network 120 includes any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 180 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The content publisher 140 provides content accessed by users of the client device 110 and provides slots in which content items selected by the online system 100 are placed. In one embodiment, a content publisher 140 is an application provider that provides an application for execution by a client device 110 or communicating data to client devices 110 for use by an application executing on the client device 110. In other embodiments, a content publisher 140 provides content (e.g., videos, pictures, news stories, and other content) or other information for presentation via a client device 110.

The content publisher 140 features locations within a page layout where one or more content items can be presented to a user from the online system 100. These content items may be sponsored by the third party systems 130 to provide value to the content publisher 140. Sponsored content items can be placed within sponsored content slots arranged vertically or horizontally in different portions of a page layout according to the preferences of a content publisher 140. In one embodiment, locations within a page layout designated for sponsored content items are segmented into a number of sponsored content slots arranged according to the dimensions of the sponsored content items provided by a third party system 130. This sponsored content is selected by the online system 100 for presentation on a client device 110 at a content publisher's 140 page or within a content publisher's 140 application executing on a client device 110.

### II. Online System

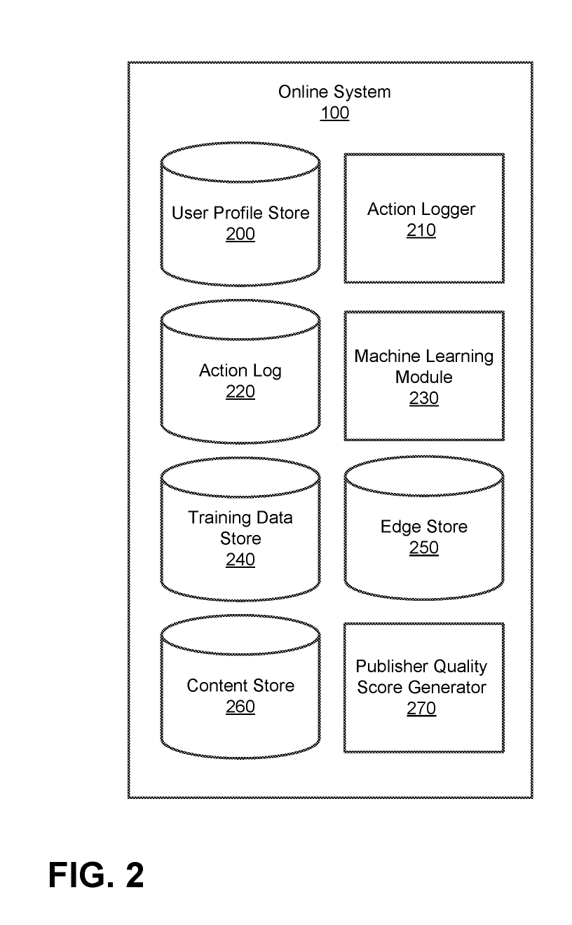

FIG. 2 is a block diagram of an online system 100 with a publisher quality score generator 270 according to one embodiment. In the embodiment illustrated in FIG. 2, the online system 100 includes a user profile store 200, an action logger 210, an action log 220, a machine learning module 230, a training data store 240, an edge store 250, a content store 260, and a publisher quality score generator 270. In other embodiments, the online system 100 may include additional, fewer, or different components for various applications. Conventional components such as network interfaces, security functions, load balancers, failover servers, management and network operations consoles, and the like are not shown so as to not obscure the details of the system architecture.

Each user of the online system 100 is associated with a user profile, which is stored in the user profile store 200. A user profile includes declarative information about the user that was explicitly shared by the user and may also include profile information inferred by the online system 100. In one embodiment, a user profile store 200 of an online system user includes multiple data fields, each describing one or more attributes of the user. Examples of information stored in a user profile store 200 include biographic, demographic, and other types of descriptive information, such as work experience, educational history, gender, hobbies or preferences, location and the like. A user profile may also store other information provided by the user, for example, images or videos. In certain embodiments, an image of a user may be tagged with information identifying the online system user displayed in an image. A user profile in the user profile store 200 may also maintain references to actions by the corresponding user performed on content items in the action log 220.

The action logger 210 receives communications about user actions internal to and/or external to the online system 100, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 100 to track user actions on the online system 100, as well as actions on third party systems 130 that communicate information to the online system 100. Users may interact with various objects on the online system 100, and information describing these interactions is stored in the action log 220. Examples of interactions with objects include: viewing videos, commenting on posts, sharing links, checking-in to physical locations via a mobile device, accessing content items, and any other suitable interactions. Additional examples of interactions with objects on the online system 100 that are included in the action log 220 include: viewing videos posted by a user's connections in the online system 100, commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with sponsored content on the online system 100 as well as with other applications operating on the online system 100. In some embodiments, data from the action log 220 is used to infer interests or preferences of a user, augmenting the interests included in the user profile store 200 of the user, and allowing a more complete understanding of user preferences.

In one embodiment, the edge store 250 stores information describing connections between users and other objects on the online system 100 as edges. Some edges may be defined by users, allowing users to specify their relationships with other users. For example, users may generate edges with other users that parallel the users' real-life relationships, such as friends, co-workers, partners, and so forth. In one embodiment, the user profile store 200 stores data describing the connections between different users of the online system 100, such as the number of friends shared between the users out of the total number of friends, the fraction of time since joining or becoming a member of the social networking system that overlaps between the two users (e.g., whether the users joined the online system at the same time or have an overlap for a certain period of time), or a combination of these signals. The record of users and their connections in the online system 100 may be called a “social graph.”

Other edges are generated when users interact with objects in the online system 100, such as expressing interest in a page on the online system 100, sharing a link with other users of the online system 100, viewing videos posted by other users of the online system 100, and commenting on posts or videos provided by other users of the online system 100. The connections between users and other objects, or edges, can be unidirectional (e.g., a user following another user) or bidirectional (e.g., a user is a friend with another user).

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 100, or information describing demographic information about a user. Each feature may be associated with a source object or user, a target object or user, and a feature value. A feature may be specified as an expression based on values describing the source object or user, the target object or user, or interactions between the source object or user and target object or user. Hence, an edge may be represented as one or more feature expressions.

The edge store 250 also stores information about edges, such as affinity scores for objects, interests, and other users. In one embodiment, affinity scores, or “affinities,” are computed by the online system 100 over time to approximate a user's interest in an object or another user in the online system 100 based on the actions performed by the user. A user's affinity may be computed by the online system 100 over time to approximate a user's affinity for an object, interest, and other users in the online system 100 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 250, in one embodiment. Alternatively, each interaction between a user and a specific object is stored as a separate edge.

The content store 260 stores objects that represent various types of content. Examples of content represented by an object include a video, page post, status update, photograph, link, shared content item, gaming application achievement, check-in event at a local business, brand page, or any other type of content. Online system 100 users may create objects stored by the content store 260, such as status updates, photos tagged by users to be associated with other objects in the online system 100, events, groups, or applications. In some embodiments, objects are received from third party systems 130 and placed in the content store 260. These objects may represent sponsored content campaigns provided by one or more third party systems 130.

Each sponsored content campaign affiliated with a third party system 130 contains criteria regarding how it is to be implemented by the online system 100. In one embodiment, criteria affiliated with sponsored content campaigns are stored with the sponsored content in the content store 260 in the online system 100. In other embodiments, these criteria may be stored in a separate system to be used by the online system 100 when needed. Typically, the criteria indicate parameters such as targeting criteria, sponsored content type, slot type, value contribution amount, and the like. A given sponsored content campaign is selected when the criteria match with that specified by the online system 100 or by a content publisher 140. These criteria will be discuss further in Section III: Publisher Quality Score Generator.

The machine learning module 230 uses machine learning techniques to train one or more models to predict an estimated conversion rate for content publishers 140. The machine learning module 230 takes, as input, data describing online system 100 users (e.g., user profile information of a target user and action performed by the target user), data describing content publishers 140, and data describing sponsored content items from content publishers 140 that report conversion actions to the online system 100. Based on the user data and trained models, the machine learning module 230 generates a score indicative of a likelihood that the target user will acquire a sponsored content item, for example, from a third party system 130. In another embodiment, the machine learning module 230 generates a score indicative of a likelihood that the target user will execute a transaction associated with the item. For example, if an online system 100 user is presented with sponsored content contained in an app, the machine learning module 230 can generate a score indicating the likelihood of the online system 100 user making a purchase within the app based on user data and trained models. This score is provided to the publisher quality score generator 270 where it is used in determining a publisher quality score for the app, in this example.

The publisher quality score generator 270 produces a publisher quality score based on an estimated conversion rate associated with presenting a sponsored content item on a content publisher 140 in comparison to an estimated conversion rate associated with presenting the sponsored content item on the online system 100. In one embodiment, information about a content publisher 140 is derived from user profile stores 200, action logs 220, and/or edge stores 250 of online system 100 users that interacted with the content publisher 140. The online system 100 uses this publisher quality score to normalize disparities in expected value that exist across content publishers 140.

### III. Publisher Quality Score Generator

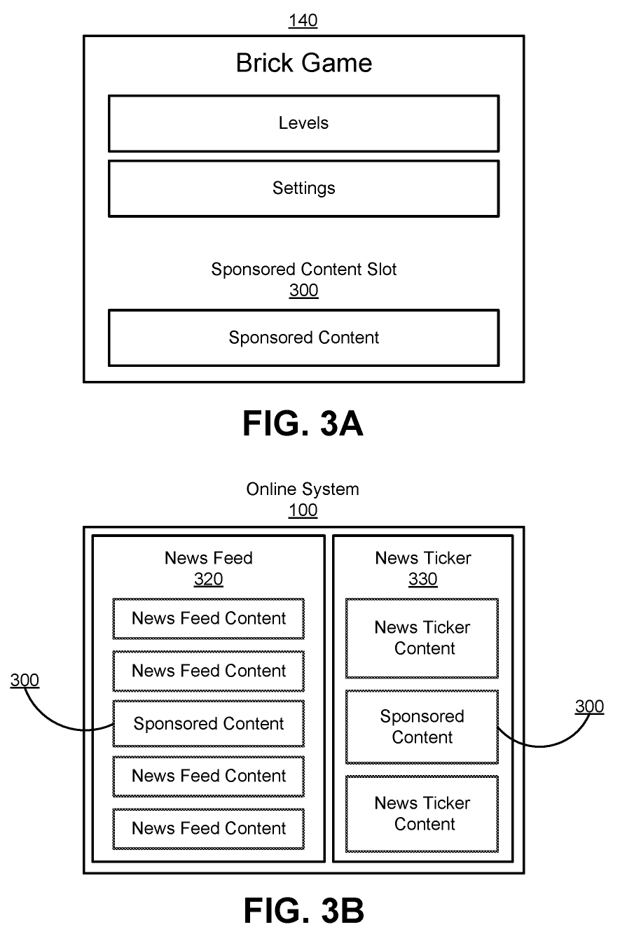

The publisher quality score generator 270 produces publisher quality scores used to normalize third party value contributions toward sponsored content items distributed across content publishers 140 that produce different respective estimated conversion rates. Due to the variety of ways in which sponsored content is presented to users across content publishers 140, there are intrinsically some content publishers 140 that drive more, or less, expected value than others. For example, an application featuring sponsored content slots arranged in a particular configuration, or page layout, might generate a higher conversion rate than another application that features a different page layout or fewer sponsored content slots. FIG. 3A illustrates a content publisher 140, Brick Game, that contains a sponsored content slot 300. FIG. 3B illustrates the same sponsored content slot 300 featured in the news feed 320 of the online system 100. Although the sponsored content items displayed within the sponsored content slots 300 is consistent across publishers, the difference in page layout presented by both publishers can result in different conversion rates. Furthermore, a difference in number of users of both publishers can result in different conversion rates. For example, the online system 100 may have more users than the content publisher 140, thus increasing the number of opportunities sponsored content items presented in sponsored content slots 300 have to receive conversion actions performed by users. Additionally, the publishers may receive user traffic with different frequencies, resulting in different conversion rates for sponsored content items. For example, the online system 100 may have users that view content in the news feed 320 and news ticker 330 in FIG. 3B more frequently than using the application, Brick Game, in FIG. 3B. This may result in increased conversion actions for the sponsored content items presented within the online system 100 than those in the content publisher 140.

Due in part to this intrinsic difference, third party systems 130 might experience a lower, or higher, expected value from sponsored content placed across different content publishers 140. This expected value is generally relative to the overall system (e.g., online system 100, other content publishers 140), which can highlight respective disparities in expected value among content publishers 140 and the online system 100. In one embodiment, the publisher quality score generator 270 generates a score for each content publisher 140 that provides conversion action metrics to the online system 100. This score reflects the content publisher's 140 ability to generate value (e.g., estimated conversion rate). In another embodiment, the publisher quality score generator 270 generates a score for each campaign 410 that provides conversion 450 data to the online system 100. This score indicates the campaign's 410 ability to generate conversions. The online system 100 can use this publisher quality score to normalize third party value contributions for placement of sponsored content items, thus helping to remove disparities in expected conversion rates across content publishers 140. In addition, the online system 100 can apply publisher quality scores to content publishers 140 or campaigns 410 that do not report conversion action metrics to the online system 100 based on a machine learning model. This publisher quality score is used by the online system 100 to normalize third party value contributions toward sponsored content, thus helping to remove disparities in expected value across content publishers 140.

### Publisher Quality Score

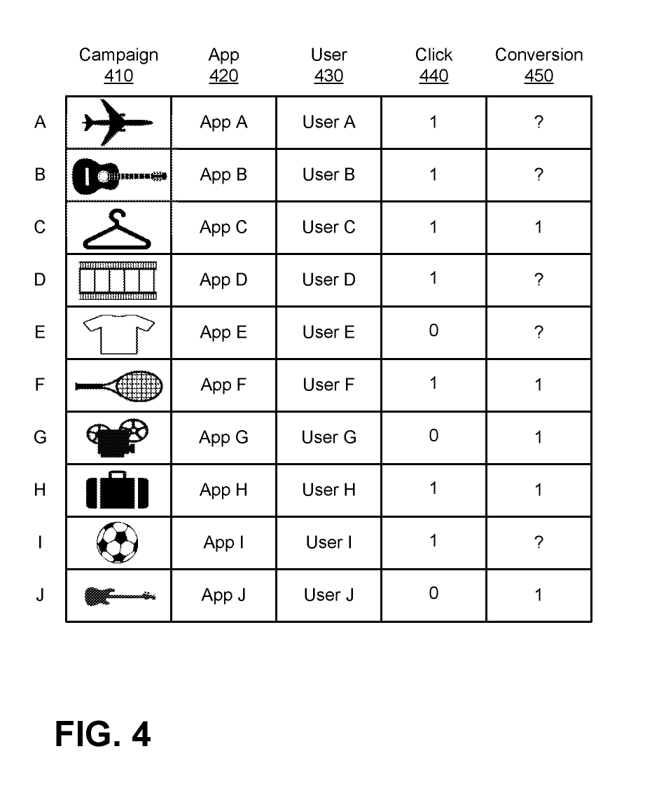

FIG. 4 illustrates an example use case in which the online system 100 collects data associated with sponsored content items presented on content publishers 140, according to one embodiment. In the embodiment illustrated in FIG. 4, the online system 100 identifies sponsored content campaigns (“campaigns 410”), as well as various online system 100 users (“users 430”) that visit content providers 140 or use applications (“apps 420”) affiliated with or provided by the content providers 140.

Each campaign 410 affiliated with a third party system 130 contains criteria regarding how it is to be implemented by the online system 100. These criteria indicate parameters such as sponsored content item type, targeting criteria, and conversion actions. A sponsored content item type identifies a category by which the sponsored content item or campaign 410 may be defined (e.g., travel, entertainment, sports, fashion, and the like). Targeting criteria indicate which type of user 430 may be most receptive to a given sponsored content type or campaign 410 in relation to descriptive information contained in the user profile store 200 of a user 430 (e.g., work experience, educational history, gender, hobbies or preferences, location and the like). In the example shown in FIG. 4, the online system 100 may identify a conversion action (“conversion 450”) related to receipt of specified events from each respective app 420 indicating that a user both installed and interacted with the app 420. These interactions vary across campaigns 410, and may include a validation of the app 420, a purchase event in the app 420, or an event in the app 420 indicating user 430 interaction with the app 420 beyond installing the app 420. In one embodiment, the conversion action may be the user interacting with the content, for example by clicking 440 or selecting the content to view a page or other item referenced by the sponsored content item.

Conversion 450 data is reported to the online system 100 and used by the publisher quality score generator 270 to normalize third party value contributions. In one embodiment, a third party system 130 can embed tracking instructions for generating tracking requests within one or more sponsored content items presented through the online system 100. For example, if a user 430 clicks 440 or otherwise interacts with a sponsored content item presented through the online system 100, the click 440 may activate a link to a content publisher 140 affiliated with the third party system 130 that provided the sponsored content item. If the sponsored content item contains embedded tracking instructions, a tracking request is generated and sent to the online system 100. In this way, the online system 100 can be notified of conversion 450 events that may, or may not, occur within the online system 100 itself (i.e., on a content publisher 140, app 420, or any other network-connected location external to the online system 100). This allows the online system 100 to collect conversion 450 information used to normalize third party value contributions, or bids, toward the placement of sponsored content items within the online system 100.

In one embodiment, a content publisher 140 can embed tracking instructions for generating tracking requests within one or more web pages of the content publisher 140 in order to track user 430 interactions. In an embodiment, the tracking instructions are associated with one or more tracking pixels. A tracking pixel is a portion of a web page, for example, a segment of HTML code that produces a transparent 1×1 image, an iframe, or other suitable object that may be embedded in a web page sent to a client device by the content publisher 140. A tracking pixel is activated, or triggered, when a web page is loaded (e.g., rendered) into a user's browser on a client device 110 for viewing. When a tracking pixel is rendered, the HTML code of the tracking pixel sends a tracking request, to the online system 100. The tracking request may include a category describing the content publisher 140 or app 420 containing the page being rendered, an identification of the user 430 of the content publisher 140 or app 420, an indication of a click 440, an indication of a conversion 450, and the like. For example, a tracking pixel may trigger on a web page of a shopping website as a user 430 is browsing products within the website. When the tracking pixel is rendered, the client device 110 sends a tracking request to the online system 100 identifying the user 430, the website, the campaign 410, the click 440, and any subsequent conversions 450.

In some instances, a content publisher 140 or app 420 affiliated with or provided by a content publisher 140 does not provide conversion 450 data to the online system 100. For example, in row D of FIG. 4, the online system 100 does not report conversion 450 data for conversion actions performed by User D on App D. In addition, Apps A, B, E, and I (located in rows A, B, E, and I, respectively) do not provide conversion 450 data to the online system 100. In one embodiment, conversion 450 data is not reported to the online system 100 due to an absence of embedded tracking instructions in one or more sponsored content items associated with a campaign 410. In another embodiment, conversion 450 data is not reported by a content publisher 140 due to an absence of tracking pixels within the content publisher 140. In yet another embodiment, this conversion 450 data may not be used by the publisher quality score generator 270 due to incorrectly labeled tracking pixels embedded within the web pages of a content publisher 140 or an app 420. However, the publisher quality score generator 270 can collect information describing the campaigns 410 associated with conversion 450 data reported to the online system 100 (e.g., Campaigns C, F, G, H, and J), the apps 420 associated with these conversions 450 (e.g., Apps C, F, G, H, and J), the users 430 that use these apps 420 (e.g., Users C, F, G, H, and J), and an indication that that a user 430 clicked 440, or otherwise interacted with, sponsored content items presented in the online system 100. The publisher quality score generator 270 can use this collected information to predict estimated conversion rates for other campaigns 410 (e.g., Campaigns A, B, D, E, and I in FIG. 4).

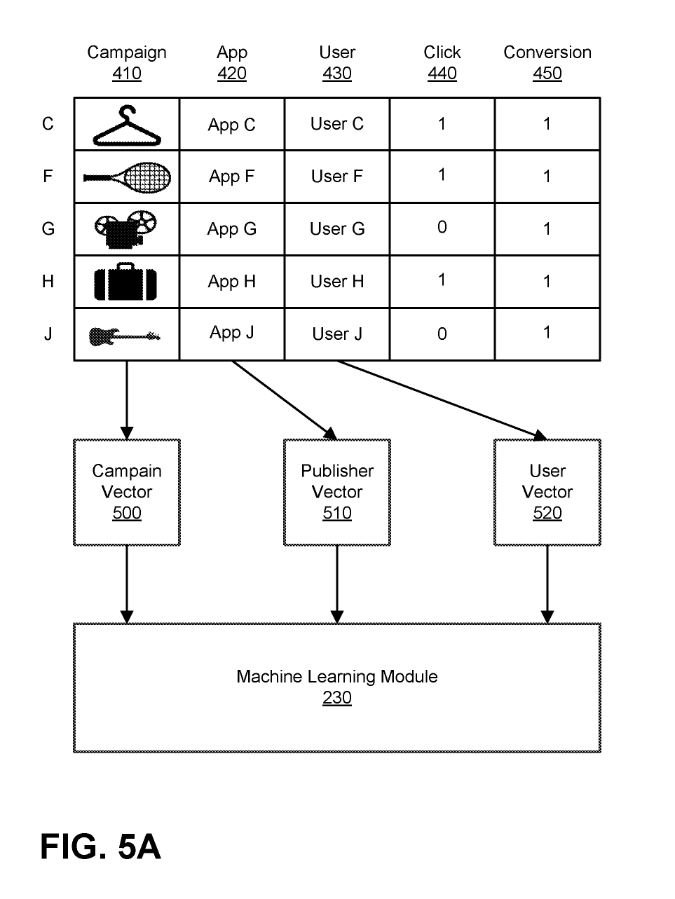

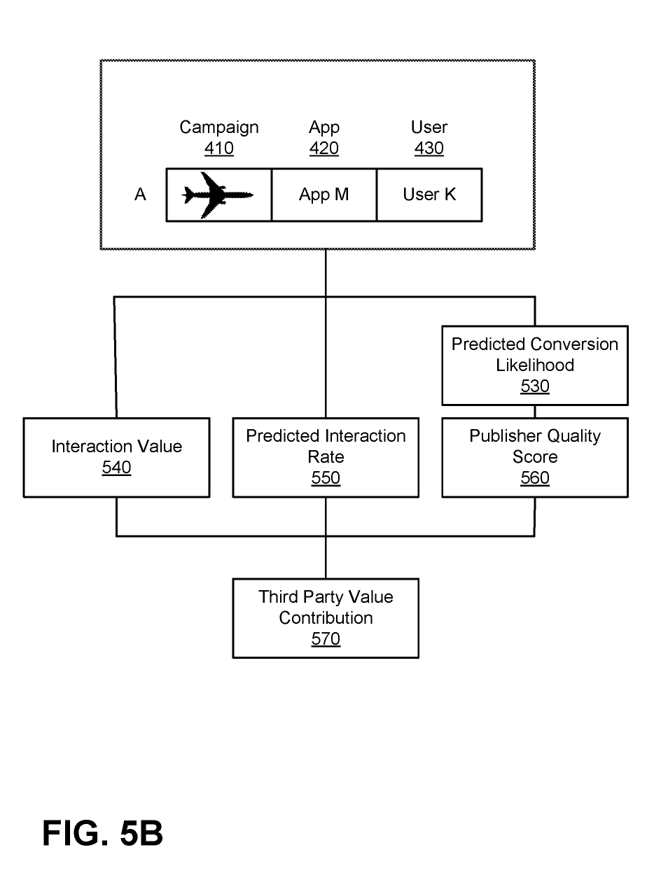

FIG. 5A illustrates a process for gathering and supplying conversion 450 data to a machine learning module 230, according to one embodiment. In FIG. 5A, the online system 100 identifies campaigns 410 that provide conversion 450 data to the online system 100. This is shown in FIG. 5A where rows C, F, G, H, and J have a conversion 450 value of “1,” indicating a presence of conversion 450 data. Responsive to identifying the presence of conversion 450 data, the online system 100 can collect data corresponding to each campaign 410, app 420, and user 430 to generate a campaign vector 500, a publisher vector 510, and a user vector 520, respectively.

The campaign vector 500 is comprised of data describing each of the campaigns 410 (e.g., type of advertisement and advertiser) that provided the online system 100 with conversion 450 data. The campaign vector 500 may include categories describing each campaign 410. In the example illustrated in FIG. 5A, the campaign vector 500 may list categories such as fashion, sports, entertainment, travel, and music (corresponding to rows C, F, G, H, and J, respectively). In one embodiment, the campaign vector 500 may include details that describe sponsored content items within each campaign 410. For example, campaigns C, F, G, H, and J further describe sponsored content items corresponding to clothing stores, tennis accessories, movie showtimes, travel accessories, and concert tickets (corresponding to rows C, F, G, H, and J, respectively). In another embodiment, the campaign vector 500 may further include sponsored content campaign criteria for each campaign 410, such as third party value contribution, targeting criteria, and a desired action to be performed by the user 430 to generate a conversion 450.

The publisher vector 510 is comprised of data describing the content and sponsored content slots 300 within apps 420 associated with conversion 450 data reported to the online system 100. In FIG. 5A, the publisher vector 510 may list Apps C, F, G, H, and J, as well as provide descriptions of each app 420 and the types of sponsored content slots 300 in which the sponsored content items were presented (e.g., banner slots, interstitial slots, sidebar slots, and the like). For example, if App F is a shopping application that displays banner-sized sponsored content slots 300 on its landing page, the publisher vector 510 would list App F as a shopping application that contains banner sponsored content slots 300. Similarly, if App G is a movie-streaming application that displays sponsored content items interstitially between segments of publisher content, the publisher vector 510 might list App G as a movie-streaming application that contains interstitial sponsored content slots 300.

The user vector 520 is comprised of data describing users 430 of the apps 420 that display sponsored content items affiliated with campaigns 410 that report conversion 450 data to the online system 100. The online system 100 can identify users 430 of the apps 420 and collect information from the user profile store 200 and/or action log 220 of each user 430 (e.g., biographic, demographic, and other types of descriptive information, such as work experience, educational history, gender, hobbies or preferences, location and the like). The user vector 520 may include this collected information for each identified user 430 of each app 420. In the example illustrated in FIG. 5A, User C visited App C and was presented with a sponsored content item associated with Campaign C. Similarly, User F visited App F and was presented with a sponsored content item associated with campaign F, and so on. Resultantly, the user vector 520 may contain a list of Users C, F, G, H, and J, as well as descriptive information from their respective user profile stores 200.

As shown in FIG. 5A, each of these vectors serves as input into the machine learning module 230. The machine learning module 230 provides data from the campaign vector 500, the publisher vector 510, and the user vector 520 to the training data store 240 in order to train a machine learning model. The publisher quality score generator 270 uses this machine learning model to predict an estimated conversion rate for campaigns 410, or apps 420, that did not supply the online system 100 with conversion 450 data, as well as campaigns 410 that are new to the online system 100 (e.g., campaigns 410 that have not yet generated conversions 450). The publisher quality score generator 270 may also apply estimated conversion rates to third party value contributions, or auction bid amounts, based on cost per click 440 (CPC) or cost per impression (CPM) in order to compare value of those activities to the value of actual conversions 450 as predicted in the estimated conversion rate. Accordingly, the publisher quality score generator 270 can adjust the third party value contribution based on this comparative value.

FIG. 5B illustrates an example of a process for determining a third party value contribution 570 for a campaign 410 that has not provided conversion 450 data to the online system 100, according to one embodiment. In the example illustrated in FIG. 4, Campaign A is associated with a sponsored content item that is presented to User A. User A subsequently clicked 440 the sponsored content item and was directed away from the online system 100 to App A, where conversion 450 data was not provided to the online system 100. In the example illustrated in FIG. 5B, Campaign A is presented on App M to User K. The publisher quality score generator 270 uses an interaction value 540, predicted interaction rate 550, predicted conversion likelihood 530, and a publisher quality score 560 to determine a third party value contribution 570 that a third party system 130 might provide to the online system 100 in order present one or more sponsored content items to User K on App M. For example, if User K frequently visits online gambling content publishers 140, and App M is an online poker application, the publisher quality score generator 270 can determine an estimated conversion rate that a campaign 410 associated with a casino might receive versus that of a clothing store and adjust a third party value contribution 570 accordingly.

The interaction value 540 is a bid amount associated with an online system 100 user interacting with a sponsored content item that is displayed within the online system 100. The interaction value 540 is specified by a third party system 130, indicating an amount of compensation the third party system 130 will provide the online system 100 each time a sponsored content item is presented to a user 430 (CPM) or each time a user 430 clicks 440 on the sponsored content item (CPC). For example, a third party system 130 may specify an interaction value 540 that it will provide to the online system 100 each time a user 430 clicks 440 on a sponsored content item presented within the online system 100. If the user 430 clicks 440 on the sponsored content item, the third party system 130 provides the online system 100 with the specified compensation. However, the interaction value 540 is fixed in that it is not adjusted by the third party system 130 at the time of auction (i.e., when the online system 100 selects one or more sponsored content items for presentation to the user 430). In addition, the interaction value 540 does not account for conversion 450 actions that occur external to the online system 100.

The predicted interaction rate 550 is an estimated rate in which a user 430 might interact with sponsored content items (e.g., click 440). The predicted interaction rate 550 is determined by the online system 100 by monitoring the click-through rate (CTR) at which users 430 click 440 on sponsored content items presented in the online system 100. For example, the online system 100 can monitor user 430 interactions with sponsored content items presented in sponsored content slots 300 such as those illustrated in FIG. 3B. The online system 100 provides the click-through rate for each user 430 to the machine learning module 230. The machine learning module 230 provides this data to the training data store 240 that generates a machine learning model used to determine a predicted interaction rate 550 for each user 430 of the online system 100. In one embodiment, the online system 100 tracks a rate at which users that were presented with a sponsored content item click 440 on a link associated with the third party system 130 that supplied the sponsored content item after viewing the sponsored content item. In another embodiment, the online system 100 tracks a rate at which users 430 that were presented with a sponsored content item register with a content publisher 140 that presented the sponsored content item after viewing the sponsored content item. The online system 100 can use the machine learning model to determine the likelihood that a given user 430 will interact with a sponsored content item based on the user's 430 previous interactions with sponsored content items displayed in the online system 100.

The predicted conversion likelihood 530 is a predicted rate of conversions 450 that a campaign 410 might receive when presenting a sponsored content item on an app 420. The predicted conversion likelihood 530 is generated by a machine learning model that is trained using data from the campaign vector 500, publisher vector 510, and user vector 520. Using the machine learning model, the online system 100 can determine an estimated conversion rate for content publishers 140 or campaigns 410 that do not report conversion 450 data to the online system 100. In addition, the machine learning model can generate a predicted conversion likelihood 530 for campaigns 410 that are new to the online system 100 or that have not yet garnered conversions 450 from users 430. The machine learning model may also generate a predicted conversion likelihood 530 for campaigns 410 that provide third party value contributions based on clicks 440 alone. In this instance, the machine learning model can generate a predicted conversion likelihood 530 that indicates a more accurate representation of value that a third party system might expect to receive in exchange for its third party value contribution 570 than that based solely on a user 430 clicking 440 a sponsored content item.

The publisher quality score is a score used by the online system 100 to normalize third party value contributions 570 for the placement of sponsored content items across content publishers 140, or apps 420, that yield varying conversion 450 rates. The publisher quality score generator 270 can collect information associated with conversion 450 events within the online system 100 by using information from the action logs 220 and edge stores 250 of users 430 of the online system 100. The publisher quality score generator 270 can use this information to determine an overall estimated conversion rate for campaigns 410 that provide sponsored content items for placement in sponsored content slots 300 within the online system 100 (e.g., such as those shown in FIG. 3B). The publisher quality score generator 270 can use this value in conjunction with the predicted conversion likelihood 530 value to determine the overall publisher quality score for a content publisher 140, app 420, or campaign 410 using the following formula:

$$publisher quality score = \frac{\begin{matrix}predicted conversion \\ likelihood on app\end{matrix}}{\begin{matrix}predicted conversion likelihood \\ on online system\end{matrix}}$$

The publisher quality score (quotient) is a percentage that indicates a comparative value for third party value contributions 570 toward campaigns 410 placed across content publishers 140, or apps 420 (numerator), in view of those placed within the online system 100 (denominator). Based on the publisher quality score 560, the online system 100 can provide discounts on third party value contributions 570 toward the placement of sponsored content items on content publishers 140 that generate fewer conversions 450 than those generated by the online system 100 for the presentation of the same sponsored content items. These discounts provide third party systems 130 with less disparity in expected value from sponsored content items placed across content publishers 140 and the online system 100. Sponsored content items placed in sponsored content slots 300 on the online system 100 and placed in sponsored content slots 300 on a content publisher 140 are unlikely to generate the same rate of conversions 450 associated with the sponsored content item. For example, the online system 100 uses a publisher quality score 560 to identify that the likelihood of a sponsored content item displayed on a content publisher 140 will generate only 50% of the conversions 450 compared to those generated by the online system 100 for the same sponsored content item. Resultantly, the online system 100 can provide the third party system 130 a 50% discount on the placement of the sponsored content item on the content publisher 140 to normalize the third party value contribution 570 and maintain expected value. In this way, the rate of conversions 450 associated with a sponsored content item displayed within the online system 100 serves as a baseline efficacy for the rate of conversions 450 produced by content publishers 140 external to the online system 100. The publisher quality score 560 is used to normalize third party value contributions 570 using the formula below:

third party value contribution=(interaction value)(predicted interaction rate)(publisher quality score)

As shown in the formula, the product of the interaction value 540, predicted interaction rate 550, and publisher quality score 560 determine the overall third party value contribution 570. Because the interaction value 540 is fixed, the online system 100 can use the predicted interaction rate 550 and publisher quality score 560 to adjust the third party value contribution 570. The online system 100 adjusts the third party value contribution 570 to account for disparities in conversion 450 rates sponsored content items receive when presented in the online system 100 and across a variety of content publishers 140 or apps 420.

### IV. Publisher Quality Score Process

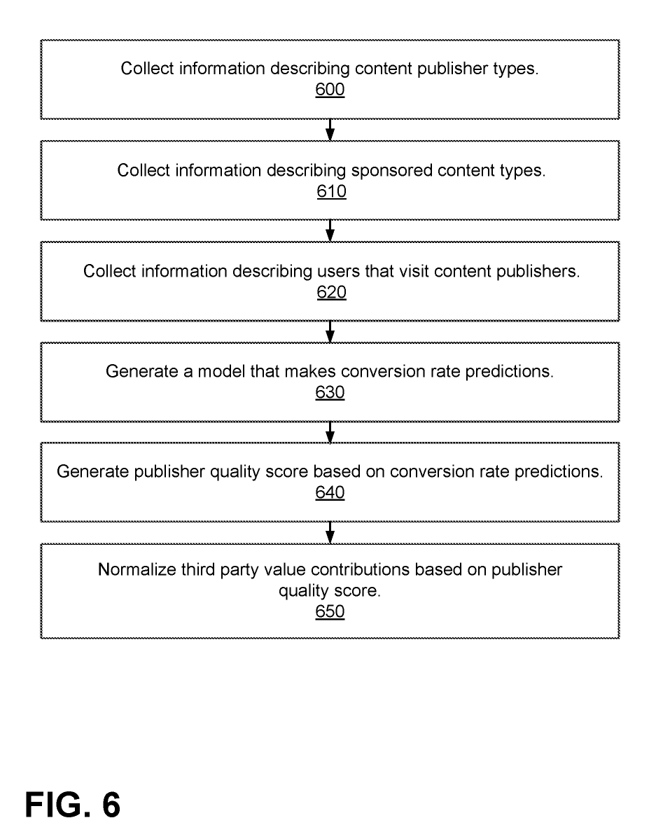

FIG. 6 is a flowchart illustrating a process for generating a publisher quality score 560 and normalizing third party value contributions 570, according to one embodiment. In the embodiment illustrated in FIG. 6, the publisher quality score generator 270 collects 600 information describing content publisher 140, or app 420, type. For example, the publisher quality score generator 270 can categorize a given content publisher 140 according to what type of content is presented on the content publisher 140 (e.g., shopping, gaming, news, and the like) and what kinds of sponsored content slots 300 are presented on the content publisher 140 (e.g., banner, interstitial, sidebar, etc.). The publisher quality score generator 270 can use this collected content publisher 140 information to generate a publisher vector 510. In addition, the publisher quality score generator 270 can collect 610 information describing sponsored content campaign 410 types. These sponsored content campaign 410 types provide categorizations for campaigns 410 based on their content and sponsored content slot 300 type. For example, information describing campaigns 410 can describe the campaign 410 such as those shown in FIG. 4 (e.g., travel, entertainment, shopping, sports, etc.). The publisher quality score generator 270 can use this collected campaign 410 information to generate a campaign vector 500. Lastly, the publisher quality score generator 270 can collect 620 information describing users 430 that visit content publishers 140, or that use apps 420 affiliated with or provided by the content publishers 140. Information describing users 430 of content publishers 140 may include information from user profile stores 200, action logs 200, and/or information describing a rate in which users 430 interact with sponsored content items presented on the online system 100 and across content publishers 140 or apps 420. The publisher quality score generator 270 can use this collected user 430 information to generate a user vector 520. The publisher quality score generator 270 sends the publisher vector 510, campaign vector 500, and user vector to the machine learning module 230 that generates 630 a model that determines a predicted conversion likelihood 530. The publisher quality score generator 270 uses the predicted conversion likelihood 530 and conversion rates from the online system 100 to generate 640 a publisher quality score 560. The online system 100 uses this publisher quality score 560 to normalize 650 third party value contribution 570 for the placement of sponsored content items within the online system 100 as well as across content publishers 140 or apps 420.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving a request to evaluate a content item for display to a user via a third-party slot provided by a content publisher;
determining an estimated conversion rate for the third-party slot by applying information describing the user, content publisher, and content item to a computer model, the estimated conversion rate predicting a rate of user interactions with the content item when displayed in the third-party slot provided by the content publisher;
determining an average conversion rate for the content item, the average conversion rate comprising an average of user interactions with the content item when displayed to users viewing the content item in a content slot on an online system separate from the content publisher;
generating a publisher quality score describing a comparative value for displaying the content item in the third-party slot compared to displaying the content item in the content slot on the online system, wherein the publisher quality score is a ratio between the estimated conversion rate and the average conversion rate;
normalizing a third party value contribution based on the publisher quality score.

2. The computer-implemented method of claim 1, wherein the computer model is a machine learning model trained with data including:
a publisher vector describing at least one content publisher associated with conversion data received by the online system, the publisher vector including a category indicating a type of content displayed on the at least one content publisher and a list of one or more third-party slot types, the list including a set of dimensions and locations of one or more third-party slots displayed on the at least one content publisher;
a campaign vector describing at least one content campaign, the at least one content campaign comprised of one or more content items previously displayed on the at least one content publisher, the campaign vector including a category indicating a type of content and a third-party slot type for each of the one or more content items;
a user vector describing at least one user of the online system that previously interacted with the one or more content items on the at least one content publisher, the user vector including biographic information, demographic information, and any other type of descriptive information stored by the online system that describes the at least one user.

3. The computer-implemented method of claim 1, wherein the information describing the content publisher includes:
a category describing the content publisher, the category indicating a type of content displayed on the content publisher; and
a list of one or more third-party slot types, the list including a set of dimensions and locations of one or more third-party slots displayed on the content publisher.

4. The computer-implemented method of claim 1, wherein the information describing the content campaign includes:
a category describing each of the one or more content items associated with the content campaign, each category indicating a type of content displayed by each of the one or more content items;
a third-party slot type for each of the one or more content items associated with the content campaign, the third-party slot type indicating a type of content slot in which a content item may be placed by the online system.

5. The computer-implemented method of claim 1, wherein the information describing the user that accesses the content publisher includes biographic information, demographic information, and any other type of descriptive information stored by the online system.

6. The computer-implemented method of claim 1, wherein the user interactions comprise application installs, post-install purchases, and clicking content items when displayed in content slots.

7. The computer-implemented method of claim 1, further comprising:
receiving one or more content items for display to a user via the third-party slot provided by the content publisher, each of the one or more content items associated with a normalized third-party value contribution, the normalized third-party value contribution;
identifying, from the received one or more content items, a content item having a highest normalized third-party value contribution; and
selecting the content item having the highest normalized third-party value contribution for display to the user via the third-party slot provided by the content publisher.

8. The computer-implemented method of claim 1, wherein the third party value contribution is a value amount provided by a third party system to the online system, the online system receiving the value amount for placing the one or more sponsored content items associated with the sponsored content campaign in third-party slots on the content publisher or in content slots on the online system.

9. The computer-implemented method of claim 8, wherein normalizing the third party value contribution comprises:
raising the value amount responsive to a publisher quality score indicating a higher estimated conversion rate than average conversion rate; or
lowering the value amount responsive to a publisher quality score indicating a lower estimated conversion rate than average conversion rate.

10. The computer-implemented method of claim 1, wherein normalizing the third-party value contribution further comprises:
adjusting the third-party value contribution based on a predicted interaction rate, the predicted interaction rate determined by a computer model that predicts a likelihood that a user will interact with a content item based on previous interactions performed by the user with one or more content items displayed on the online system.

11. A non-transitory computer readable storage medium having instructions encoded thereon that, when executed by a processor, cause the processor to perform the steps including:
receiving a request to evaluate a content item for display to a user via a third-party slot provided by a content publisher;
determining an estimated conversion rate for the third-party slot by applying information describing the user, content publisher, and content item to a computer model, the estimated conversion rate predicting a rate of user interactions with the content item when displayed in the third-party slot provided by the content publisher;
determining an average conversion rate for the content item, the average conversion rate comprising an average of user interactions with the content item when displayed to users viewing the content item in a content slot on an online system separate from the content publisher;
generating a publisher quality score describing a comparative value for displaying the content item in the third-party slot compared to displaying the content item in the content slot on the online system, wherein the publisher quality score is a ratio between the estimated conversion rate and the average conversion rate;
normalizing a third party value contribution based on the publisher quality score.

12. The non-transitory computer readable storage medium of claim 11, wherein the computer model is a machine learning model trained with data including:
a publisher vector describing at least one content publisher associated with conversion data received by the online system, the publisher vector including a category indicating a type of content displayed on the at least one content publisher and a list of one or more third-party slot types, the list including a set of dimensions and locations of one or more third-party slots displayed on the at least one content publisher;
a campaign vector describing at least one content campaign, the at least one content campaign comprised of one or more content items previously displayed on the at least one content publisher, the campaign vector including a category indicating a type of content and a third-party slot type for each of the one or more content items;
a user vector describing at least one user of the online system that previously interacted with the one or more content items on the at least one content publisher, the user vector including biographic information, demographic information, and any other type of descriptive information stored by the online system that describes the at least one user.

13. The non-transitory computer readable storage medium of claim 11, wherein the information describing the content publisher includes:
a category describing the content publisher, the category indicating a type of content displayed on the content publisher; and
a list of one or more third-party slot types, the list including a set of dimensions and locations of one or more third-party slots displayed on the content publisher.

14. The non-transitory computer readable storage medium of claim 11, wherein the information describing the content campaign includes:
a category describing each of the one or more content items associated with the content campaign, each category indicating a type of content displayed by each of the one or more content items;
a third-party slot type for each of the one or more content items associated with the content campaign, the third-party slot type indicating a type of content slot in which a content item may be placed by the online system.

15. The non-transitory computer readable storage medium of claim 11, wherein the information describing the user that accesses the content publisher includes biographic information, demographic information, and any other type of descriptive information stored by the online system.

16. The non-transitory computer readable storage medium of claim 11, wherein the user interactions comprise application installs, post-install purchases, and clicking content items when displayed in content slots.

17. The non-transitory computer readable storage medium of claim 11, further comprising:
receiving one or more content items for display to a user via the third-party slot provided by the content publisher, each of the one or more content items associated with a normalized third-party value contribution, the normalized third-party value contribution;
identifying, from the received one or more content items, a content item having a highest normalized third-party value contribution; and
selecting the content item having the highest normalized third-party value contribution for display to the user via the third-party slot provided by the content publisher.

18. The non-transitory computer readable storage medium of claim 11, wherein the third party value contribution is a value amount provided by a third party system to the online system, the online system receiving the value amount for placing the one or more sponsored content items associated with the sponsored content campaign in third-party slots on the content publisher or in content slots on the online system.

19. The non-transitory computer readable storage medium of claim 18, wherein normalizing the third party value contribution comprises:
raising the value amount responsive to a publisher quality score indicating a higher estimated conversion rate than average conversion rate; or
lowering the value amount responsive to a publisher quality score indicating a lower estimated conversion rate than average conversion rate.

20. The non-transitory computer readable storage medium of claim 11, wherein normalizing the third-party value contribution further comprises:
adjusting the third-party value contribution based on a predicted interaction rate, the predicted interaction rate determined by a computer model that predicts a likelihood that a user will interact with a content item based on previous interactions performed by the user with one or more content items displayed on the online system.
